(19) United States
(12) Patent Application Publication
(10) Pub. No.: US 2010/0149608 A1
(43) Pub. Date: Jun. 17, 2010

(54) SCANNING APPARATUS WITH FLATBED AND SHEET-FEEDING SCANNING FUNCTIONS

(75) Inventors: Yen-Cheng Chen, Hsinchu (TW); Ting-Kuo Chu, Hsinchu County (TW)

Correspondence Address: COVENANT IP CONSULTING CO., P.O. BOX 34-306 TAIPEI CITY, TAIPEI, 10499, TW

(73) Assignee: AVISION INC., Hsinchu (TW)

(21) Appl. No.: 12/635,795

(22) Filed: Dec. 11, 2009

(30) Foreign Application Priority Data
Dec. 12, 2008 (TW) 97148613

(51) Int. Cl. H04N 1/04

(52) U.S. Cl. 358/498

(57) ABSTRACT

A scanning apparatus, which supports flatbed and sheet-feeding scanning of document, includes a first scanning unit and a second scanning unit. The first scanning unit includes a first scanning chassis which scans a document in a first main scanning direction. The second scanning unit is disposed beneath the first scanning unit and electrically connected with the first scanning unit. The second scanning unit includes a second scanning chassis which scans a document in a second main scanning direction different from the first main scanning direction. Preferably, the first and the second scanning units provide the flatbed scanning and sheet-feeding scanning functions, respectfully.

This application claims the benefit of Taiwan application Serial No. 97148613, filed Dec. 12, 2008, the subject matter of which is incorporated herein by reference.

### BACKGROUND OF THE INVENTION

1. Field of the Invention

The invention relates in general to a scanning apparatus, and more particularly to a scanning apparatus with flatbed and sheet-feeding scanning functions.

2. Description of the Related Art

Due to the advance in the image scanning technology and the high-speed transmission interface, scanners have become more accessible and popular for use both in household and business. Scanners capture the images of physical objects (such as documents, photos or books) and transmit the image data of the physical objects as an electronic file to a computer. In this way physical objects are digitalized and users can conveniently transmit or edit the image data. The image scanning technology nowaday makes the applications of an image more flexible and versatile.

In addition to the performance of the scanners, such as the image quality (resolution) generated by the scanners and scanning speed during scan, the space taken up by the scanner is also one of great concerns for the users.

Conventionally, there are two types of scanners, namely, flatbed scanners and sheet-feeding scanners. The flatbed scanner, normally comprising an A4 sized or an A3 sized scanning platen, is mainly used for scanning a single-sheet document, a thick cardboard, or pages of a bound document or a book. The sheet-feeding scanner automatically feeds in and scan a larger volume of documents, saving both time and labor spent on scanning operations. However, the to-be-scanned documents or sheets may have different sizes, such as small sized booklets or large sized documents. To satisfy the needs for flatbed and sheet-feeding scanning, user has to purchase two scanners of different scanning types, and it is a great waste of space and money. For example, a flatbed scanner capable of scanning an A3 sized document must have at least an A3 sized scanning platen; therefore, this flatbed scanner occupies a planar area with at least an A3 sized space, which either at home or office is a considerable area space the users would have to spare for placing the scanner.

In addition to the quality of the scan images, it is also an important development goal to design a compact scanner with flatbed scanning and sheet-feeding scanning functions.

### SUMMARY OF THE INVENTION

The invention is directed to a scanning apparatus, which provides both of the flatbed scanning function and the sheet-feeding scanning function, and which with its compact design takes up less space.

According to a first aspect of the present invention, a scanning apparatus comprising a first scanning unit and a second scanning unit is provided. The first scanning unit comprises a first scanning chassis which scans in a first main scanning direction. The second scanning unit is disposed beneath the first scanning unit and electrically connected with the first scanning unit. The second scanning unit comprises a second scanning chassis which scans in a second main scanning direction. The second main scanning direction is different from the first main scanning direction.

The invention will become apparent from the following detailed description of the preferred but non-limiting embodiments. The following description is made with reference to the accompanying drawings.

### BRIEF DESCRIPTION OF THE DRAWINGS

FIG. 1 shows a scanning apparatus according to a preferred embodiment of the invention;

FIG. 2 shows a side view of the scanning apparatus of FIG. 1;

FIG. 3A and FIG. 3B illustrate formats of a first maximum document size and a second maximum document size, respectively; and

FIG. 4A and FIG. 4B illustrate a supporting pin of a first scanning unit and a recess of a second scanning unit respectively according to an embodiment of the invention.

### DETAILED DESCRIPTION OF THE INVENTION

The present embodiment of the invention discloses a scanning apparatus, which provides both of the flatbed scanning and sheet-feeding scanning functions. The scanning apparatus of the invention has advantages of occupying less space without compromising the scanning size; for example, occupying a space as small as an A4 sized document and able to scan an A3 sized document. The scanning apparatus providing both of the flatbed scanning function and sheet-feeding scanning function is exemplified below as an embodiment of the invention. However, the scanning apparatus of the embodiment disclosed herein is used for illustrating the invention, but not for limiting the scope of the invention. Also, the specification and the drawings are to be regarded as an illustrative sense rather than a restrictive sense. Additionally, the drawings used for illustrating the embodiment and applications of the present invention only show the major characteristic parts in order to avoid obscuring the present invention.

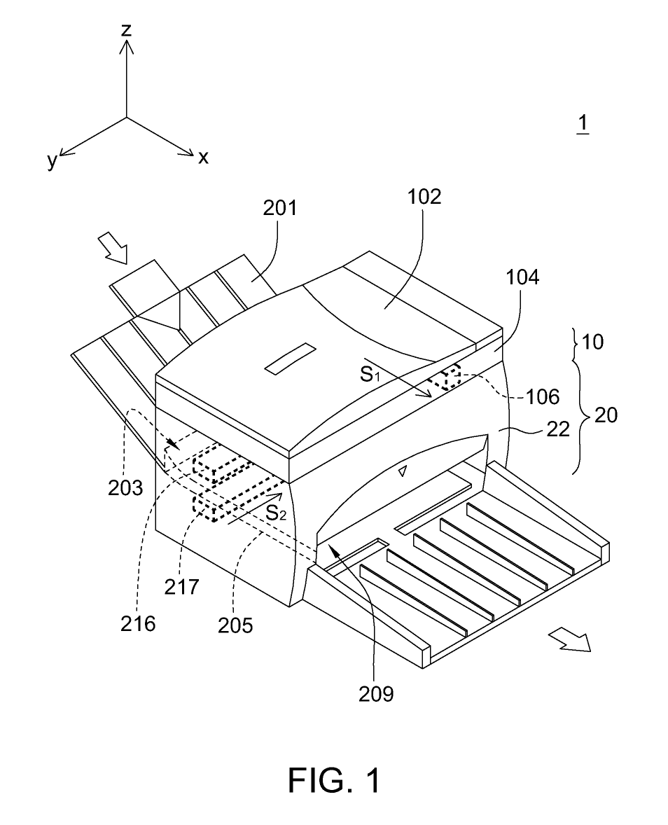

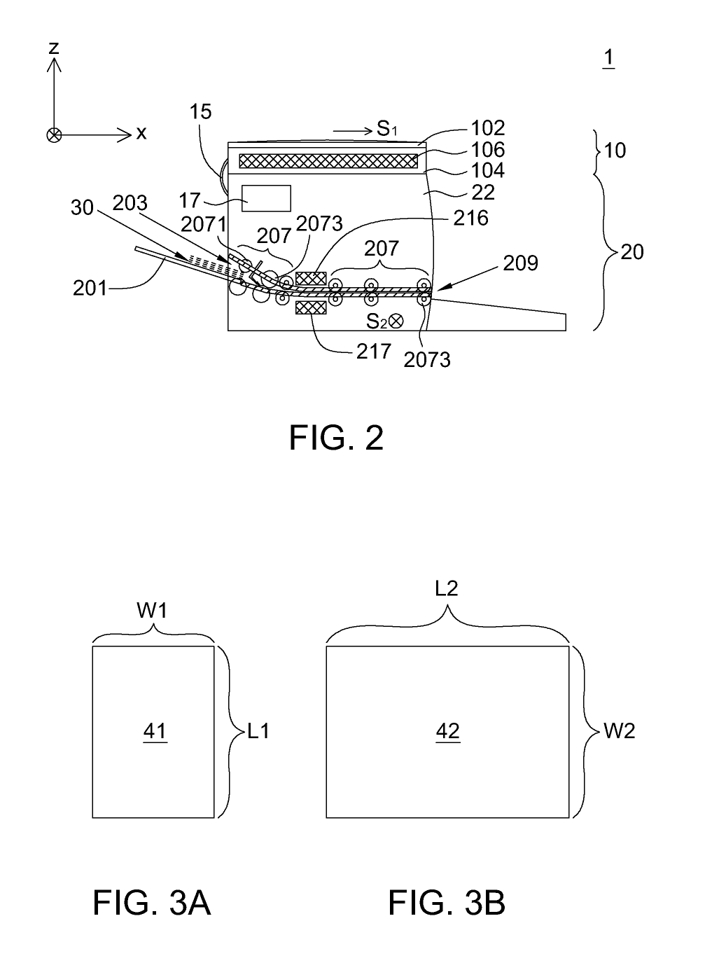

Referring to both FIG. 1 and FIG. 2. FIG. 1 shows a scanning apparatus according to a preferred embodiment of the invention. FIG. 2 shows a side view of the scanning apparatus of FIG. 1. The scanning apparatus 1 comprises a first scanning unit 10 and a second scanning unit 20, wherein the second scanning unit 20 is disposed beneath and electrically connected with the first scanning unit 10. The first scanning unit 10 has a flatbed comprising a transparent platen (not illustrated), and an object, such as a sheet of document or a photo with a to-be-scanned image, is placed on the transparent platen. The first scanning unit 10 performs the flatbed scanning on the object. The second scanning unit 20 has an automatic document feeder (ADF) capable of automatically scanning a large volume of sheets or photos for performing the sheet-feeding scanning function.

The first scanning unit 10 with flatbed scanning function comprises an upper cover 102, a housing 104, and a first scanning chassis 106. The first scanning chassis 106, which is disposed beneath the transparent platen (for placing the to-be-scanned document, not illustrated) and inside the housing 104, scans a sheet in a first main scanning direction S1. The first scanning chassis 106 may comprise elements, such as an image sensor, a photoelectrical conversion circuit, an analog-to-digital converter and a memory, but no further elaboration and restriction are given below. The first main scanning direction S1 is the direction in which the photo sensing elements of the image sensor of the first scanning chassis 106 are aligned.

The second scanning unit 20 includes a sheet feeder 207 and a second scanning chassis 216. As shown in FIG. 2, the sheet feeder 207 has several sets of rollers (such as one set of feeding rollers 2071 and several sets of delivering rollers 2073), and a single or multiple sheets of document 30 placed in the feed tray 201 are automatically delivered into the paper entrance 203 of the second scanning unit 20 one by one. The sheet 30 passes a scanning region and then is scanned by the second scanning chassis 216 of the second scanning unit 20 which is located within the scanning region. The sheet feeder 207 is driven by a motor (not illustrated) so that the document is steadily transported in a feeding path 205. After the scanning operation is completed, the document is outputted from the paper exit 209.

The second scanning chassis 216 of the scanning apparatus 1 includes photoelectric conversion elements, such as a charge-coupled device (CCD) image sensor or a contact image sensor (CIS). Other types of image sensors are also applicable for use in the first scanning chassis 106 and the second scanning chassis 216 of the scanning apparatus 1 of the present invention without particular restriction.

The second scanning unit 20 with sheet-feeding scanning function can perform a single-sided or a double-sided scanning operation on a document. In the present embodiment of the invention, the double-sided scanning operation is used for exemplification, but the invention is not limited thereto. As indicated in FIG. 1 and FIG. 2, the second scanning unit 20 comprises a second scanning chassis 216 and a third scanning chassis 217, which are respectively disposed above and under the feeding path 205 for scanning the opposite sides of the sheet 30, such as the front side and the back side. Also, when the sheet 30 is transported in the feeding path 205 (thereby generating a relative movement with respect to the second scanning chassis 216 and the third scanning chassis 217), the second scanning chassis 216 and the third scanning chassis 217 of the second scanning unit 20 scan in a second main scanning direction S2. The second main scanning direction S2 is different from the first main scanning direction S1. According to the present embodiment of the invention, the second main scanning direction S2 (i.e. parallel to the Y-direction) is substantially perpendicular to the first main scanning direction S1 (i.e. parallel to the X-direction). The second main scanning direction S2 is the direction in which the photo sensing elements of the image sensors of the second scanning chassis 216 and the third scanning chassis 217 are aligned.

According to the scanning apparatus of the invention, the first scanning unit 10 is operable with a first maximum document size for the flatbed scanning function, and the second scanning unit 20 is operable with a second maximum document size for the sheet-feeding scanning function, wherein the second maximum document size is greater than the first maximum document size. In an embodiment, an example of the first maximum document size is the size A4, and an example of the second maximum document size is the size A3.

Referring to FIG. 3A and FIG. 3B, formats of a first maximum document size and a second maximum document size are respectively illustrated. The first maximum document size 41 has a first length L1 and a first width W1, and the second maximum document size 42 has a second length L2 and a second width W2. The width of the paper entrance 203 of the second scanning unit 20 substantially corresponds to the second width W2 of the second maximum document size 42. For example, if the first maximum document size 41 for the flatbed scanning function of the first scanning unit 10 is size A4, and the second maximum document size 42 for sheet-feeding scanning function of the second scanning unit 20 is size A3, then the width of the paper entrance 203 of the second scanning unit 20 substantially corresponds to the length of the second width of the second maximum document size A3, that is, 297 mm.

Formats of size A4 and size A3 respectively as the first and second maximum document sizes are taken as example. When the first scanning unit 10 is operable with a first maximum document size of A4 for the flatbed scanning function, the size of the transparent platen of the first scanning unit 10 is substantially equal to size A4 to accommodate sheets of sizes equal to or less than A4. Examples of the applicable document sizes include the standard sizes such as sizes A4˜A10, B5˜B10, C5˜C8, DL, C76, or any special sized documents whose widths and lengths are not greater than 210 mm and 297 mm, respectively. When the second scanning unit 20 is operable with a second maximum document size of A3 for the sheet-feeding scanning function, the widths of the paper entrance 203 and the paper exit 209 of the second scanning unit 20 are substantially equal to the short side of size A3, that is 297 mm, and various documents or photos whose size is no more than size A3 can be scanned by the second scanning unit 20 using the sheet-feeding function. Examples of the applicable document sizes include the standard sizes such as sizes A3˜A10, B4˜B10, C4˜C8, DL, C76, or any special sized documents whose widths or lengths are not greater than 297 mm.

In a practical application, the planar area of the housing 104 of the first scanning unit 10 may be approximately equal to that of the body 22 of the second scanning unit 20 disposed under the first scanning unit 10. For example, the planar area of the housing 104 of the first scanning unit 10 and the planar area of the body 22 of the second scanning unit 20 may be substantially equal to size A4. Alternatively, they could be unequal in size. For example, the width of the planar area of the body 22 of the second scanning unit 20 could be smaller than the width of the planar area of the housing 104 of the first scanning unit 10. Such, the scanning apparatus 1 of the embodiment not only possesses both of the flatbed scanning and sheet-feeding scanning functions, but also occupies less space. For example, the scanning apparatus 1 with an A4 sized scanning platen in the first scanning unit 10 is also capable of scanning an A3 sized document by the second scanning unit 20.

As indicated in FIG. 2, the second scanning unit 20 is electrically connected with the first scanning unit 10 by an electrical connector 15, such as a standard parallel port (SPP), a universal serial bus (USB) or any transmission interface, wired or wireless. A control unit 17 controls these two electrically connected scanning units 10 and 20. The user can select the first scanning unit 10 and/or the second scanning unit 20 by a user interface connected with the control unit 17 to activate the flatbed scanning function and/or the sheet-feeding scanning function. In the present embodiment, the control unit 17 is disposed in the second scanning unit 20 for controlling the first scanning unit 10.

In the present embodiment, the first scanning unit 10 is detachably disposed above the second scanning unit 20. When a paper jam occurs in the second scanning unit 20, the user only needs to detach and displace the first scanning unit 10 from the second scanning unit 20, and the upper cover of the second scanning unit 20 could be opened for removing the sheet of paper jammed in the second scanning unit 20. There are many implementations of disposition of the first scanning unit 10. For example, at least one first fixing member is disposed on the top surface of the second scanning unit 20, and at least one second fixing member is disposed on the bottom surface of the first scanning unit 10. The first fixing member is correspondingly coupled or engaged with the second fixing member for fixing the first scanning unit 10 to the second scanning unit 20. In one embodiment, the top surface of the second scanning unit 20 is approximately equal to the planar area of the body 22 of the second scanning unit 20.

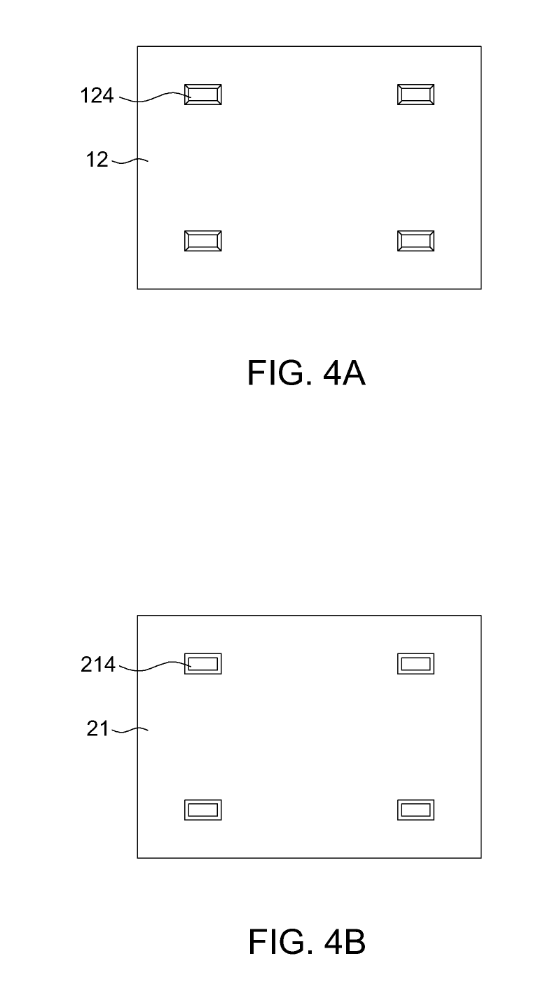

FIG. 4A and FIG. 4B illustrate a supporting pin of the first scanning unit 10 and a recess of the second scanning unit 20 respectively according to an embodiment of the invention. The first scanning unit 10 has at least one supporting pin 124 (that is, the second fixing member) projected from the bottom surface 12, at least one recess 214 (that is, the first fixing member) is formed on the top surface 21 of the second scanning unit 20, wherein the position and the shape of the supporting pin 124 fit that of the recess 214. When the supporting pin 124 is inserted into the recess 214, the first scanning unit 10 is fixed on the top of the second scanning unit 20. In FIG. 4A and FIG. 4B, four recesses 214 and four supporting pins 124 are illustrated. The four recesses 214 are respectively disposed near four corners of the top surface 21 of the second scanning unit 20, and the four supporting pins 124 are respectively disposed near four corners on the bottom surface 12 of the first scanning unit 10 and corresponding to the positions of the recesses 214.

Besides the mechanical engagement as illustrated above (i.e. the recess 214 and the supporting pin 124), the first fixing member and the second fixing member can be designed as two magnets with opposite polarities, so as to fix the first scanning unit 10 to the second scanning unit 20 by magnetic force. Also, the fixation between the first scanning unit 10 and the second scanning unit 20 could be achieved by other ways, such as using an adhesive tape or Velcro. All the implementations disclosed above provide the user to conveniently assemble or detach the first scanning unit 10 from the second scanning unit 20, and could be applied in the embodiment of the invention without any particular restriction.

According to the scanning apparatus disclosed in the above embodiments of the invention, the first scanning unit 10 and the second scanning unit 20 are respectively disposed atop and beneath. The first scanning unit 10 disposed atop provides the flatbed scanning function, and comprises a first scanning chassis for scanning in a first main scanning direction S1. The second scanning unit 20 disposed beneath the first scanning unit 10 provides the sheet-feeding scanning function, and comprises a second scanning chassis for scanning in a second main scanning direction S2 which is different from the first main scanning direction S1. The scanning apparatus of the invention providing both of the flatbed scanning and sheet-feeding scanning functions occupies less space, so the user can get rid of the cumbersome conventional scanner and save more room for better utilization.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning apparatus, comprising:
a first scanning unit, comprising a first scanning chassis which scans in a first main scanning direction; and
a second scanning unit, disposed beneath the first scanning unit and electrically connected with the first scanning unit, the second scanning unit comprising a second scanning chassis which scans in a second main scanning direction, and the second main scanning direction being different from the first main scanning direction.

2. The scanning apparatus according to claim 1, wherein the second main scanning direction is substantially perpendicular to the first main scanning direction.

3. The scanning apparatus according to claim 2, wherein the size of the first scanning unit is different from that of the second scanning unit.

4. The scanning apparatus according to claim 3, wherein the first scanning unit provides a flatbed scanning function, and the second scanning unit provides a sheet-feeding scanning function.

5. The scanning apparatus according to claim 4, wherein the first scanning unit is operable with a first maximum document size for the flatbed scanning function, and the second scanning unit is operable with a second maximum document size for the sheet-feeding scanning function, wherein the second maximum document size is greater than the first maximum document size.

6. The scanning apparatus according to claim 5, wherein the first maximum document size is size A4, and the second maximum document size is size A3.

7. The scanning apparatus according to claim 5, wherein the first maximum document size has a first length and a first width, and the second maximum document size has a second length and a second width, and the first length is equal to the second width.

8. The scanning apparatus according to claim 7, wherein the second scanning unit has a paper entrance whose width substantially corresponds to the second width of the second maximum document size.

9. The scanning apparatus according to claim 1, wherein the second scanning unit comprises a sheet feeder for delivering a document past a scanning region at which the document is scanned by the second scanning chassis.

10. The scanning apparatus according to claim 1, wherein the second scanning unit and the first scanning unit are electrically connected by an electrical connector.

11. The scanning apparatus according to claim 10, wherein the second scanning unit comprises a control unit for controlling the first scanning unit.

12. The scanning apparatus according to claim 1, wherein the first scanning unit is detachably disposed above the second scanning unit.

13. The scanning apparatus according to claim 12, wherein the second scanning unit has at least one first fixing member disposed on a top surface thereof, the first scanning unit has at least one second fixing member disposed on a bottom surface thereof, and the first fixing member is engaged with the second fixing member to fix the first scanning unit to the second scanning unit.

14. The scanning apparatus according to claim 13, wherein the first fixing member is a recess, and the second fixing member is a supporting pin disposed in the recess to secure the first scanning unit above the second scanning unit.

15. The scanning apparatus according to claim 14, wherein the second scanning unit has four recesses respectively located near four corners of the top surface, and the first scanning unit has four supporting pins located near four corners of the bottom surface and corresponding to the positions of the recesses.

16. The scanning apparatus according to claim 13, wherein the first fixing member and the second fixing member are two magnets with opposite polarities for fixing the first scanning unit to the second scanning unit by magnetic force.

17. The scanning apparatus according to claim 1, wherein the second scanning unit has a double-sided scanning function.

18. The scanning apparatus according to claim 17, wherein the second scanning unit further comprises a third scanning chassis which scans a document in the second main scanning direction.
